(19) United States
(12) Patent Application Publication
(10) Pub. No.: US 2009/0171746 A1
(43) Pub. Date: Jul. 2, 2009

(54) METHOD FOR PROVIDING SEARCH SERVICE AND SYSTEM FOR EXECUTING THE METHOD

(75) Inventors: Woo Sung Lee, Seoul (KR); Ra Young Yang, Seoul (KR); Jun Seok Na, Seoul (KR)

Correspondence Address: HUSCH BLACKWELL SANDERS LLP, 720 OLIVE STREET, SUITE 2400, ST. LOUIS, MO, 63101, US

(73) Assignee: NHN Corporation, Kyunggi-do (KR)

(21) Appl. No.: 11/719,949

(22) PCT Filed: Nov. 24, 2005
(86) PCT No.: PCT/KR05/03982

§ 371 Date: May 22, 2007

(30) Foreign Application Priority Data
Nov. 24, 2004 (KR) 10-2004-0096717

(51) Int. Cl. G06Q 30/00; G06F 17/10; G06Q 10/00; G06F 17/30

(52) U.S. Cl. 705/10; 707/5; 705/14; 707/E17.014

(57) ABSTRACT

The search service providing method according to the present invention includes: maintaining a search listing database including a keyword, a search listing associated with the keyword, a bid amount, an exposure index, and/or an advertiser identifier associated with the search listing, computing an average click rate for each of the search listings, computing the exposure index based on the average click rate and the bid amount for each search listing and recording the exposure index in the search listing database in association with the search listing to be updated, receiving a search request including a keyword from a user, selecting a predetermined number of the search listings whose exposure index ranks high from the search listings associated with the keyword with reference to the search listing database, and generating a search result list including the predetermined number of the selected search results and providing the search result list to the user.

### CROSS REFERENCE TO RELATED APPLICATIONS

This application is a U.S. National Phase Application of International Application PCT Application No. PCT/KR2005/003982 filed on Nov. 24, 2005, which claims the benefit of priority from Korean Patent Application No. 10-2004-0096717 filed on Nov. 24, 2004. The disclosures of International Application PCT Application No. PCT/KR2005/003982 and Korean Patent Application No. 10-2004-0096717 are incorporated herein by reference.

### TECHNICAL FIELD

The present invention relates to a method of providing search services and a search system executing the method, and more particularly, to a method of selecting search listings based on an average click rate and a bid amount of each search listing and a search listing system executing the method.

### BACKGROUND ART

Currently, a search system providing search services not only provides a search listing according to a search request of a user but also provides a so-called “keyword advertisement services” in which, as a cost of providing the search listing to the user or selecting the provided search listing by the user, a predetermined advertisement cost is charged to an advertiser registering the search listing.

On the other hand, in order to generate a predetermined advertisement effect in which a search listing of an advertiser is exposed to a user, the user recognizes the search listing or selects the search listing to move to a web page associated with the advertiser, the search listing of the advertiser may be arranged in a position and a form that the user can easily recognize in a search listing page.

Since there is an enormous amount of information capable of being searched on the Internet, a number of search listings provided according to a search request of a user can only increase. Accordingly, a case in which a list of search listings according to a search request reaches several tens of pages often occurs. Therefore, an advertiser desires that the advertiser's own search listing is provided at the top of a list of search listings, or in a more distinctive form. Hereinafter, a search result list designates a list of search listings provided in a position higher than others or in a more distinctive form.

However, in the case a plurality of search listings is registered for a keyword advertisement with respect to a keyword, it is impossible or unsuitable to provide the entire plurality of the search listings in the top or in a distinctive form. Accordingly, a search system has to perform a process of selecting search listings included in the search listing provided by the keyword advertisement service from the search listings registered with respect to the keyword.

Korean Patent Laid-Open No. 2002-0019042 discloses a configuration in which a search system arranges search listings according to a bid amount registered by an advertiser to provide to a user requesting a search in the case of providing keyword advertisement services. Namely, the search system provides a list, in a form in which a search listing having a bid amount higher than other search listings is arranged at the top, to the user. Namely, the search system providing keyword advertisement services according to a conventional technology selects search listings to be included in a search result list, based on the bid amount.

On the other hand, a configuration is known, in which search listings are selected and provided according to the degree of association or preference between a keyword requested by a user and search listings to be provided corresponding to the search request in a search system not providing keyword advertisement services.

There are many known methods of measuring the degree of association or preference between a keyword and a search listing or a keyword and information provided in association with a search listing. One of the methods is to measure according to how many users select a search listing provided according to a search request. Namely, the search listing selected by many users may have a high degree of association or preference in association with the keyword.

However, the described degree of association or preference is an element difficult to be included in keyword advertisement services charging an advertisement cost on an advertiser as a cost of being included in the search result list and provided to users. Accordingly, in the case of providing keyword advertisement services, the search system according to the conventional technology can only select a search listing included in the search result list depending on a bid amount.

On the other hand, in the case a provided search listing included in the search result list to be well recognized does not correspond to desired information or does not sufficiently provide desired information, there is a danger of reducing reliability with respect to a search system providing search service.

Accordingly, NHN Inc. that is the applicant of the present invention and provides search services including keyword advertisement services in the web page naver, www.naver.com, has invented a method of selecting search listings included in a search result list by considering not only a bid amount but also how many users select the search listing, namely, a click rate that is a ratio of a number of times in which a predetermined search listing is provided to users and a number of times in which the provided search listing was selected by the users.

However, as a result of the applicant's experiments by using a database populated in a process of providing keyword advertisement services to the web page, in the case only the click rate is used in a process of selecting a search listing, search listings included in the search result list may change dramatically.

Namely, since the click rate is determined according to selection of the users, in comparison with the bid amount, fluctuation is great according to a period of time, a time of day, whether there is a related a social issue, or with no special cause. There is a problem in that it is difficult to estimate what search listing will be included in the search result list, which is different from the conventional technology that only considers the bid amount, as a case in which a search listing is selected at one point in time but not selected at another time.

If the described problem is not solved, since an advertiser cannot estimate whether the advertiser's search listing is selected by controlling the bid amount, it is difficult to determined how much the proper bid amount is to find the same search listing again because a user receives a different search listing whenever searching.

Accordingly, the applicant of the present invention gets to develop a search service providing method and a search system executing the method, which can solve the problem of violent fluctuation of search listings included in the search result list, varying with a change in click rates, in which, in order to a search listing included in a search result list, a bid amount meeting a purpose what it was provided to do of keyword advertisement services is reflected, and in order to provide a search listing that is deemed to be associated with a keyword to users, a click rate is reflected.

### DISCLOSURE OF INVENTION

### Technical Goals

To improve the described conventional technology, the present invention provides a search service providing method and search system which select a search listing by considering a bid amount associated with a search listing and an average click rate computed with respect to the search listing.

The present invention also provides a search service providing method and search system which select a search listing based on a bid amount and an average click rate, thereby guaranteeing quality of a search listing provided according to a keyword advertisement service.

The present invention also provides a search service providing method and search system which select a search listing by using an average click rate whose variance is smaller than a click rate so that an advertiser may estimate what search listing is selected.

The present invention also provides a search service providing method and search system which determine a value of M according to a number of times of inputting a keyword to compute an average click rate and compute an average click rate by reflecting click rate of unit period whose number of exposures, for example, a number of providing a search listing, is more than the value of M, thereby better guaranteeing a smaller variance.

### Technical Solutions

To achieve the described goals and solve the problems of the conventional technology, according to the present invention, there is provided a method of providing search service in a search system, including: maintaining a database storing a plurality of search listings; computing an average click rate for each of the search listings, the average click rate being an average value of a plurality of unit period click rates for the search listings, wherein each of the unit period click rates is obtained by dividing the number of clicks on the search listing by the number of impressions of the search listing for a specified unit time period; computing the exposure index based, at least in part, upon the average click rate and the bid amount for each search listing; updating the exposure index stored in the database; searching the database for search listings corresponding to a keyword in response to a search request received from a searcher; identifying a predetermined number of search listings having keywords generating a match with the search request, the predetermined number of the search listings being selected based, at least in part, upon the exposure index; generating a search result list by arranging the identified search listings; and displaying the generated search result list in response to the search request. Each stored search listing is associated with at least one keyword, an advertiser, a bid amount, and an exposure index.

According to an aspect of the present invention, the exposure index may be determined by a value of multiplying the average click rate by the bid amount.

According to another aspect of the present invention, the exposure index is acquired by computing a weighted average click rate by adding a first weight to the average click rate; computing a weighted bid amount by adding a second weight to the bid; computing a multiplication value of the weighted average click rate and the weighted bid; and determining the computed multiplication value to be the exposure index.

According to still another aspect of the present invention, the plurality of unit period click rates for the average click rate include unit period click rates whose number of exposure exceeds a predetermined value during each specified unit time period.

According to yet another embodiment of the present invention, the identifying N of the unit periods whose number of exposures is more than M in the unit period in the order of closest to the present point in time, for each of the search listings includes: computing an average of an input number for a second period, the input number being a number of times of inputting the keyword associated with the search listing by the users; and determining a value of M in proportion to the computed average of the input number.

### BRIEF DESCRIPTION OF DRAWINGS

FIG. 1 is a diagram illustrating network connection of a search system according to the present invention;

FIG. 2 is a flowchart illustrating a search service providing method according to an embodiment of the present invention;

FIG. 3 is a diagram illustrating an example of a data structure included in a search listing database employed according to an embodiment of the present invention;

FIGS. 4 and 5 are diagrams illustrating a table in which, with respect to a search listing associated with a predetermined keyword, click rate with respect to a predetermined search listing for each day is recorded;

FIG. 6 is a diagram illustrating a table showing an example of an exposure index, bid amount, advertisement execution amount, and a registration time of a search listing with respect to a predetermined search listing in order to explain the present invention;

FIG. 7 is a block diagram illustrating a search system according to another embodiment of the present invention; and

FIG. 8 is an internal block diagram of a general use computer apparatus capable of being employed in performing the search service providing method according to the present invention.

### BEST MODE FOR CARRYING OUT THE INVENTION

Hereinafter, the present invention will be described in detail with reference to the attached drawings.

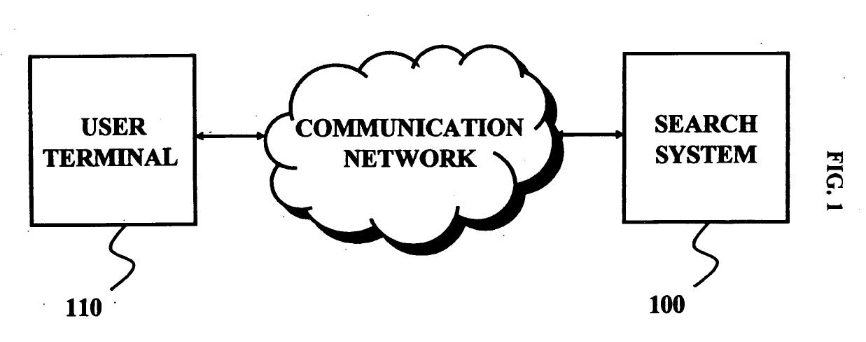

FIG. 1 is a diagram illustrating network connection of a search system 100 according to the present invention.

The search system 100 maintains a search listing for each keyword in a predetermined search listing database, when a search request with respect to a keyword is inputted from a user terminal 110, and transmits a search result list including search listings corresponding to the keyword to the user terminal 100.

A user may input a search request to the search system 100 by using the user terminal 110 and may receive a search result list corresponding to the search request. The user terminal 100 designates a communication terminal such as a personal digital assistant (PDA), a smart phone, a handheld PC, and a mobile phone, capable of accessing the search system 100 via wired or wireless Internet network by including a predetermined communication module such as a code division multiple access (CDMA) module, a Bluetooth module, an infrared communication module (IrDA), and a wired/wireless LAN card.

The search system 100 according to the present invention determines what search listing is selected and provided from a plurality of search listings corresponding to a keyword or what search listing is placed in a first location of a search listing web page, according to an exposure index computed based on 1) a bid amount and 2) an average click rate provided with respect to each of the search listings corresponding to the keyword by an advertiser.

The bid amount indicates a maximum cost that the advertiser intends to pay as an advertisement cost in the case a search listing of the advertiser is provided to a user in association with a predetermined keyword and the user selects the search listing. A detailed meaning of the average click rate will be described in the following embodiments.

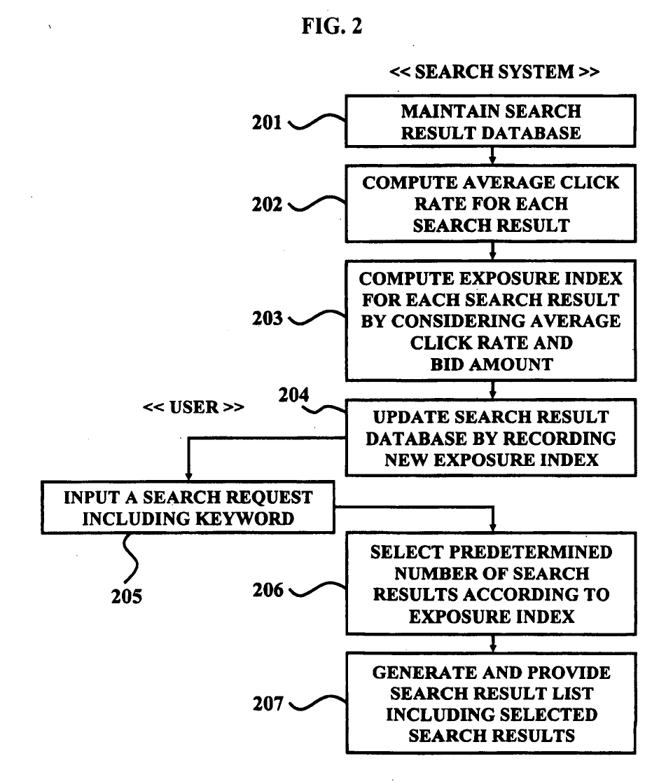

Hereinafter, a search listing providing method according to an embodiment of the present invention will be described with reference to FIG. 2. FIG. 2 is a flowchart of the search service providing method according to the present embodiment.

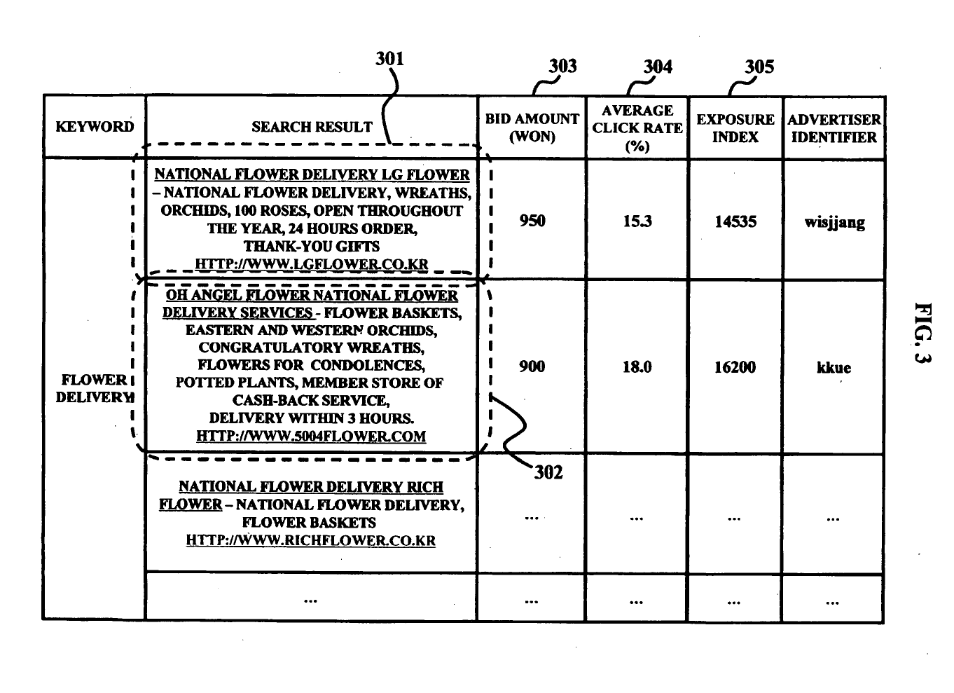

In Step 201, the search system 100 maintains a search listing database including a keyword, a search listing associated with the keyword, a bid amount associated with the search listing, an exposure index associated with the search listing, and/or an advertiser identifier associated with the search listing. FIG. 3 is a diagram illustrating an example of a data structure included in the search listing database. Each of the data included in the search listing database is regularly or irregularly updated. For example, in the case a new advertiser registers a new search listing corresponding to the keyword, the search listing associated with the keyword is additionally recorded. The search listing is information provided to a user according to a search request and may be used as information including link information to a predetermined web page to provide a link to the web page.

In Step 202, the search system 100 computes an average click rate with respect to each search listing. The average click rate is an average of unit period click rates for a certain period elapsing immediately before a present point in time. Hereinafter, a case in which the unit period is determined to be 1 day will be explained as an example. This is just an example, and the unit period may be randomly, empirically, statically, or diversely determined by an administrator of the search system 100, such as, for example, 1 hour, 10 hours, or 2 days.

The click rate may be computed by dividing a number of clicks by a number of exposures. The number of exposures indicates a number of times of providing a predetermined search listing to a user according to a keyword advertisement search. The number of clicks indicates a number of times of selecting the provided search listing by the users.

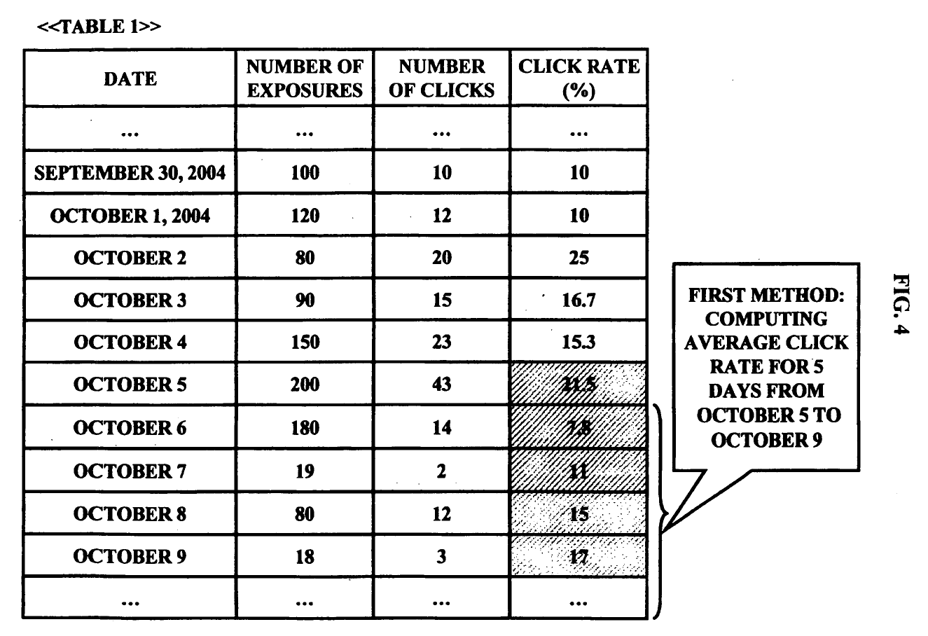

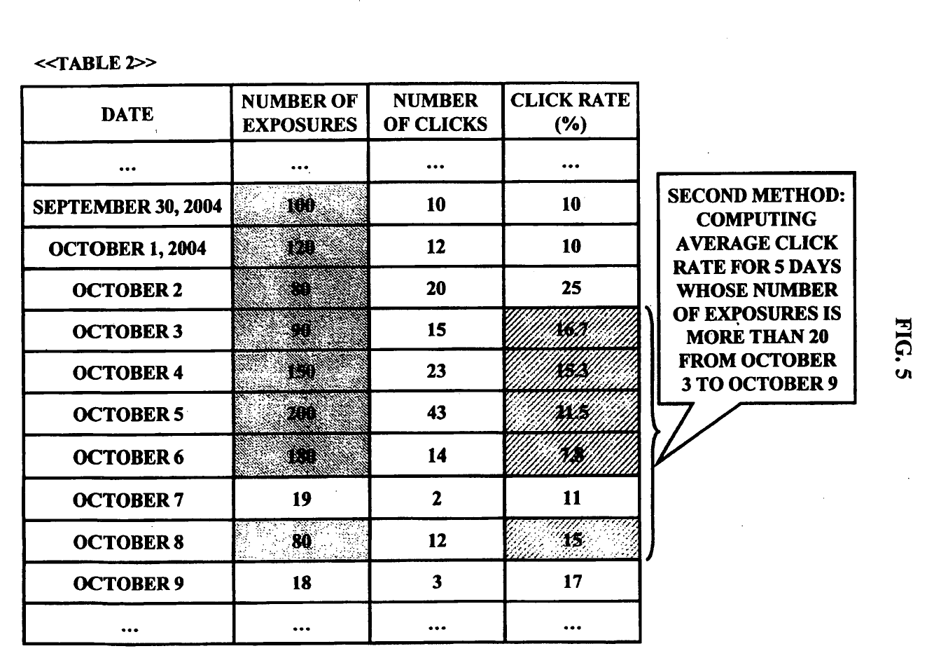

The average click rate may be differently computed according to what the certain period is determined to be. Hereinafter, a process of computing an average click rate will be described with reference to FIGS. 4 and 5.

(1) A case of Computing an Average Click Rate According to a First Method

In Table 1 of FIG. 4, with respect to a search listing associated with a predetermined keyword, a click rate of a predetermined search listing for each day is recorded. For example, in Table 1, a click rate with respect to a search listing 301 for each day is computed in association with a keyword “flower delivery”.

In the first method, a certain continuous period elapsing immediately before a present point in time is determined to be the certain period. Referring to Table 1, if a present point in time is 10 o'clock, Oct. 10, 2004, sequential days previous to the present time, for example, a continuous period from 0 o'clock, Oct. 5, 2004 to 24 o'clock, Oct. 9, 2004 may be determined to be the certain period.

Accordingly, when a click rate inputted everyday from 0 o'clock, Oct. 5, 2004 to 24 o'clock, Oct. 9, 2004 are added and divided by 5 days, the average click rate may be computed. Referring to Table 1, an average click rate with respect to the search listing 301 is as shown below.

$$Average click rate of search listing 301 = \frac{( 21.5 + 10.6 + 5.3 + 15 + 15 ) ( \% )}{5 ( days )} \approx 13.5$$

(2) A Case of Computing an Average Click Rate According to a Second Method

In the second method, the sum of a predetermined N unit periods is determined to be the certain period.

The N unit periods, namely, N days, may be not continuous, different from the first method. According to the second method, the search system 100 identifies N days whose number of exposures for a day is more than M, for example, 5 days, in the order of closest to a present point in time.

If a value of M is 20, there are slant lines for days whose number of exposures is more than 20, in Table 2 of FIG. 5. For example, there is Oct. 8, 2004 in which 80 exposures are inputted.

The search system 100 may identify 5 days whose number of exposures is more than 20, in reverse order of the flow of time from the present point in time 10 o'clock, Oct. 31, 2004. The search system 100 adds each click rate of the identified days and divides the sum by 5, thereby computing the average click rate. Referring to Table 2, the average click rate of the search listing 301 is as shown below.

$$Average click rate of search listing 301 = \frac{16.7 + 15.3 + 21.5 + 7.8 + 15 ) ( \% )}{5 ( days )} \approx 15.3$$

On the other hand, in the present embodiment, for convenience of description, though a relatively short average click rate of 5 days is computed, the administrator of the search system 100 may determine what length of time is used to compute the average click rate, namely, what the certain period is determined to be, by using an empirical or statistical method. For example, the search system 100 may compute the average click rate for 30 days elapsing immediately before a present point in time.

Also, according to another embodiment of the present invention, M may be determined for each keyword by reflecting a number of times of inputting the keyword. The input number of the keyword, which is a number of times that users input the keyword, may reflect popularity of the keyword. For example, the search system 100 may compute an average of a number of times of inputting the keyword for a certain continuous period elapsing immediately before a present point in time, for each unit period and may determine the value of M in proportion to the average for each of the unit periods. In order to distinguish the certain period determined for computing the average click rate and the certain period determined for computing the average of the number of times of inputting the keyword for each unit period, hereinafter, the latter is designated as a second period. The second period may be selected by the administrator of the search system 100 and may be selected by considering the certain period, N days, determined for computing the average click rate.

For example, in the case the second period is determined to be 30 days, if the keyword “flower delivery” is totally inputted to 3000 times from the users for past 30 days, an average of the number of times of inputting the keyword “flower delivery” for unit period is computed as 3000÷30=100.

The search system 100 may compute M for each keyword in proportion to the day average of the number of times of inputting the keyword “flower delivery” for 30 days. For example, M may be computed as shown below.

$$M associated with keyword '' flower delivery '' = 5 \% of daily average of the number of times of inputting keyword ' ' flower delivery '' for 30 days = 100 \times 20 \% = 20$$

Namely, with respect to the search listing associated with the keyword “flower deliver”, the search system 100 may compute the average click rate with respect to days whose number of exposures is more than 20.

On the other hand, though M is determined to be 20% of the day average in the present embodiment, the administrator of the search system 100 may statically, empirically determine how much of the day average is reflected onto the value of M, such as 10%.

The average click rate computed according to the first method or second method, as described below, is a factor reflected to a process of selecting a search listing with respect to the keyword.

Also, as described above, since the average click rate is computed based on a number of exposures, which is a number of times of providing and exposing a search listing to a user in association with a predetermined keyword and a click rate that is a ratio of a number of times that the user clicks a predetermined search listing, the average click rate reflects user preferences or the degree of association between a keyword and a search listing. Also, since the average click rate has a characteristic of a moving average of click rates for several days elapsing immediately before a present point in time, the average click rate has a smaller variance than a click rate for each day computed for each day according to a predetermined search listing.

Referring to Table 2 of FIG. 5, a number of exposures with respect to the search listing 301 at October 10 is 70 and a click rate is 12, if an average click rate for N days, namely, 5 days, is computed on October 11 according to the second method, a newly computed average click rate is as shown below.

$$Newly computed average click rate = \frac{( 15.3 + 21.5 + 7.8 + 15 + 12 ) ( times )}{5 ( days )} \approx 14.3$$

Accordingly, comparing to the previously computed average click rate 15.3, with the newly computed average click rate, there is a difference of no more than −1. On the other hand, looking over a number of clicks for each day, in comparison to a click rate 17% on October 9, a click rate of a previous day, October 10, is 12% and a difference between them is 5.

Accordingly, in comparison with a case of selecting a search listing by reflecting a unit period click rate, such as a click rate for each day, in the case a search listing is selected by reflecting the average click rate, the possibility of a change in the selected search listing becomes decreased.

On the other hand, the search system 100 may periodically compute the average click rate. For example, the average click rate may be computed at 2 am every day.

In Step 203, the search system 100 computes an exposure index for each search listing based on the average click rate computed with respect to the search listing and a bid amount associated with the search listing.

1) According to an embodiment of the present invention, the exposure index is computed as described below.

Exposure index=average click rate×bid

2) Also, according to another embodiment of the present invention, the exposure index is computed as described below.

$$\begin{matrix}Exposure index = weighted average click rate \times weighted bid \\ = ( average click rate + a ) \times ( bid + b )\end{matrix}$$

The a is a first weight added to the average click rate, and the b is a second weight added to the bid. According to how to determine the first weight and the second weight, the administrator of the search system 100 may determine whether preference or relation is more strongly reflected or a bid amount is more strongly reflected.

The administrator of the search system 100 may determine the proper a and the b according to a statistical or empirical method.

The exposure index according to the present embodiment is computed in association with i) a predetermined keyword ii) for each search listing iii) based on an average click rate and bid. Referring to FIG. 3, an average click rate of the search listing 301 associated with the keyword “flower delivery” is 15.3, and bid amount presented by an advertiser registering the search listing 301 is 950 won. Accordingly, the exposure index with respect to the search listing 301 associated with the keyword “flower delivery” is computed as 15.3×950=14535 from average click rate×bid amount.

Accordingly, it may be understood by those skilled in the art that the exposure index varies in the case the advertiser registers the changed bid amount or the average click rate changes. Namely, since the exposure index is computed based on the average click rate, the extent the users prefer the search listing 301 is reflected onto the exposure index.

Accordingly, since the advertiser can register the search listing 301 with respect to keywords “flower delivery” and “wreaths”, respectively, the exposure index may be computed for each keyword and search listing.

Also, the search system 100 may update the exposure index with respect to a predetermined search listing associated with a predetermined keyword whenever the bid amount changes or the average click rate changes. Also, the search system 100 may periodically compute the exposure index by considering loads on the system.

In Step 204, the search system 100 records the exposure index computed for each search listing in association with the search listing in the search listing database to update. Referring to the search listing database of FIG. 3, it is shown that an exposure index 305 is computed by multiplying an average click rate 304 and a bid amount 303.

In Step 205, the user transmits a search request with respect to a predetermined keyword to the search system 100. For example, the keyword is “flower delivery”.

In Step 206, according to the search request, the search system 100 selects a predetermined number of search listings whose exposure index is high from search listings associated with the keyword by referring to the search listing database. For example, the search system 100 may select five search listings whose exposure index is high.

Referring to FIG. 3, if there are 19000, 18000, 17000, 16500, 16200 (in the case of a search listing 302), 14535 (in the case of the search listing 301), 14000, . . . , five search listings whose exposure index is 19000, 18000, 17000, 16500, or 16200 are selected. Accordingly, since the exposure index of the search listing 301 is 14535, that is, sixth, the search listing 301 is not included in the five search listings.

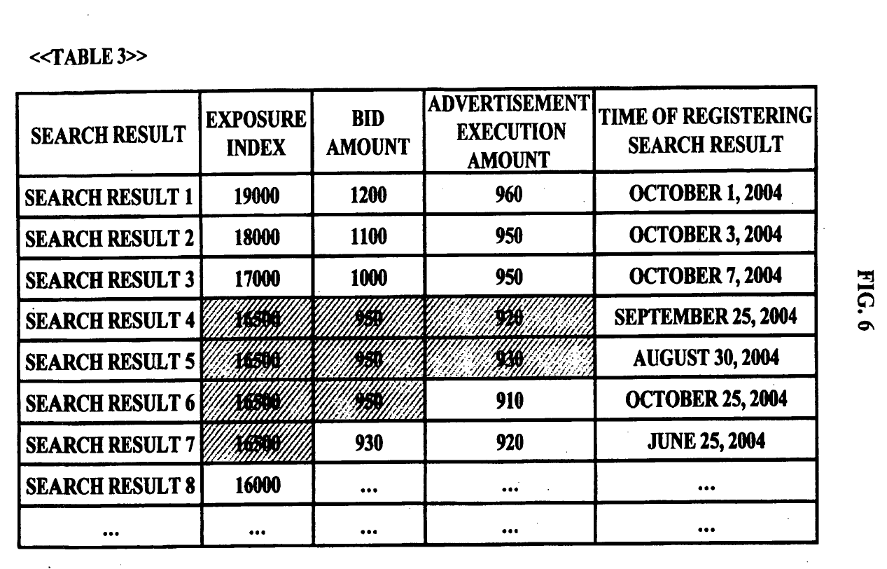

Also, according to another embodiment of the present invention, in the case the search system 100 cannot select the top five because there are search listings whose exposure index is the same, just five search listings can be selected by giving precedence as below. In Table 3 of FIG. 6, there is an example of an exposure index, bid amount, advertisement execution amount, and registration time of a search listing for each search listing associated with the keyword “flower delivery”. In Table 3, a case of arranging the search listings according to the exposure index is illustrated.

Because of the search listings 4 through 7 whose exposure index is 16500, it is not easy to select the top 5, for the search system 100. Accordingly, the search system 100, according to the present embodiment, gives preference to a search listing whose bid amount is high in the case the exposure index is the same.

Referring to Table 3, the search listing 7 has a bid amount smaller than the search listings 4 through 6 whose exposure index is the same. Accordingly, the search system 100 does not select the search listing 7.

On the other hand, since the search listings 4 through 6 still have the same priority in spite of also considering the bid amount, it is not easy to select the top 5 search listings, for the search system 100. Accordingly, according to another embodiment of the present invention, with respect to the search listings whose exposure index and bid amount are the same, the search system 100 selects the search listing by further considering an advertisement execution amount.

As described above, the bid amount indicates a maximum cost that the advertiser intends to pay as an advertisement cost. Actually, an advertisement cost to be charged to the advertiser may be different from the bid amount. In the present specification, an advertisement execution amount indicates an advertisement cost actually charged to the advertiser when the users select a search listing. For example, the search system 100 may determine the bid amount to be the advertisement execution amount, or may determine an amount in which a certain amount is added to a bid amount of a search listing corresponding to a rank next to the search listing to be an advertisement cost.

Also, according to still another embodiment of the present invention, in the case the top five search listings still cannot be selected in spite of also considering the exposure index, the bid amount, and the advertisement execution amount, a registration day of the search listings is further considered to select an antecedently registered search listing.

Accordingly, the search system 100 may determine a predetermined number of search listings by considering i) an exposure index, ii) a bid amount with respect to search listings whose exposure index is the same, iii) an advertisement execution amount with respect to search listings whose exposure index and bid amount are the same, and iv) a search listing registration time with respect to search listings whose exposure index, bid amount, and advertisement execution amount are the same.

Referring to Table 3 of FIG. 6, with respect to the search listings 4 through 7 whose exposure index is the same, the search listings 4 through 6 are selected by considering the bid amount. With respect to the search listings 4 through 6 whose exposure index and bid amount are the same, the search listings 4 and 5 are selected by further considering the advertisement execution amount. Considering the advertisement execution amount, since the top five search listings are all selected as the search listings 1 through 5, in the case of Table 3, the search system 100 is not required to further consider a search listing registration time.

In Step 207, the search system 100 generates and provides a search result list including the selected five search listings to the user. Namely, the search system 100 transmits the search result list to the user terminal 110.

Referring to FIG. 3, in the case of comparing the search listing 301 with the search listing 302, the search listing 302 whose bid amount is low but average click rate is higher is selected to be the search listing included in the search result list instead of the search listing 301 coming up with a higher bid amount. Accordingly, according to the present embodiment, the advertiser may select i) a method of increasing a bid amount and ii) a method of proposing a bid amount at a certain degree and search listings are constructed of forms and contents which are preferred by users such that a lot of the users may select, such that the search listing of the advertiser is included in a search result list to be provided to the users. The bid amount is used as a basis for computing an advertisement execution amount that is an advertisement cost charged to the advertiser in the case each of the search listings is click-selected by the user. Therefore, for the advertiser, the bid amount cannot be haphazardly increased.

Accordingly, according to the present invention, there are effects of i) providing a search listing preferred by users by reflecting a click rate with respect to a search listing in selecting the search listing, ii) guaranteeing a search listing provided whenever a search is requested to not be excessively varied, in this regard by using an average value of unit period click rate for a certain past period instead of a click rate with respect to the search listing, and iii) the advertiser, considering not only a bid amount but also quality of a search listing in order to increase probability of selecting the advertiser's own search listing. Accordingly, according to the present invention, the quality of the search listing provided by the search system 100 is increased, thereby increasing preference of users with respect to search services provided by the search system 100. Namely, the users prefer the search services provided by the search system 100 more than other search services.

Also, since an advertiser knowing that the advertiser's own search listing is not preferred by users by referring to an average click rate increases a bid amount in order to include the advertiser's own search listing in a search result list, an earning rate in the search system 100 may be increased. Particularly, according to the present invention, since the fluctuation in an average click rate is small, an advertiser may estimate at what degree of a bid amount an advertiser's search listing can be selected.

On the other hand, though a search listing is selected when a search request is inputted in Step 205 in the described embodiment, this is an exemplary example. The search system 100 may previously select the top 5 search listings whose exposure index is high for each keyword in real time or periodically, and may provide the previously selected five search listings to a user when a search request of the user is received.

Also, the search system 100 may generate a search result list to arrange five search listings included in the search result list according to an order of exposure. Also, the search system 100 may generate the search result list to arrange the five search listings according to a bid amount. Also, the search system 100 may enable the five search listings to be newly arranged by using a rolling method whenever the search result list is provided to a user. The present invention relates to a method of selecting a predetermined number of search listings included in a search result list, and the scope of the present invention is not limited by that once selected search listing is arranged in what order and form while the search listing is provided to a user.

Also, the embodiments of the present invention include a computer readable medium including a program instruction for executing various operations realized by a computer. The computer readable medium may include a program instruction, a data file, and a data structure, separately or cooperatively. The program instructions and the media may be those specially designed and constructed for the purposes of the present invention, or they may be of the kind well known and available to those skilled in the art of computer software arts.

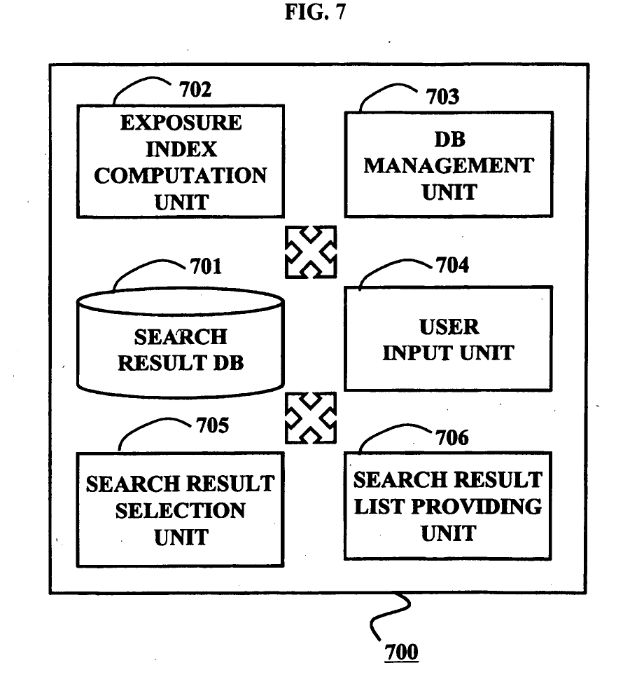

Hereinafter, a search system according to another embodiment of the present invention will be described. FIG. 7 is a block diagram illustrating the search system 700 according to the present embodiment.

The search system 700 includes a search listing database 701, an exposure index computation unit 702, a database management unit 703, a user input unit 704, a search listing selection unit 705, and a search result list providing unit 706.

The search listing database 701 includes a keyword, a search listing associated with the keyword, a bid amount associated with the search listing, an exposure index associated with the search listing, and/or an advertiser identifier associated with the search listing. As described below, the exposure index for each search listing, included in the search database 701, is updated in real time or periodically whenever the exposure index computation unit 702 computes the exposure index.

The exposure index computation unit 702 computes a number of exposures for each search listing associated with each keyword for each unit period, which is a number of times of providing the search listing to a user. For example, in the case a day is determined to be a unit period, a number of times of providing the search listing to users from 0 o'clock to 12 o'clock of the day is computed.

Also, in the case the search listing is provided to the user for each search listing associated with each keyword, the exposure index computation unit 702 computes a number of clicks, for each unit period, for example, everyday, which is a number of times of selecting the search listing by the users.

Also, the exposure index computation unit 702 computes a unit period click rate from a number of exposures and a number of clicks for each unit period computed respectively for each search listing in association with each of the keywords. The unit period click rate may be computed as (number of clicks for each unit period÷number of exposures for each unit period).

Next, the exposure index computation unit 702 computes an average click rate that is an average of click rates for a certain continuous period elapsing immediately before a present point in time. For example, the exposure index computation unit 702 may compute an average of click rates for the past 30 days. The certain period is determined to be an N unit period. In the case a day is determined to be the unit period as in the present embodiment, the certain period is corresponding to N days. Hereinafter, a case in which 30 days are determined to be N days will be described.

In this case, as the described embodiment, the average click rate may be computed by adding click rates for 30 consecutive days and dividing by 30 or may be computed by selecting 30 days which satisfy a predetermined condition, adding click rates of the selected days, and dividing by 30.

In detail, the exposure index computation unit 702 selects 30 days elapsing immediately before a present point in time from those days whose number of exposures of the search listing is more than M.

Also, according to another embodiment of the present invention, the exposure index computation unit 702 may determine a value of M for each keyword by considering a number of times of inputting the keyword. For example, the search system 100 may compute unit period average of the number of times of inputting the keyword for a second period elapsing immediately before a present point in time and may determine the value of M in proportion to the average. The second period may be selected by the administrator of the search system 100 and may be selected by considering a certain period, for example, N days, which is selected for computing the average click rate.

The exposure index computation unit 702 computes an exposure index with respect to the search listing based on the average click rate computed as described above and a bid amount registered by an advertiser of the search listing. For example, the exposure index computation unit 702 may compute the exposure index by multiplying the average click rate by the bid amount. Also, the exposure index computation unit 702 may compute the exposure index by multiplying a weighted average click rate, in which a first weight is added to the average click rate, by a weighted bid amount, in which a second weight is added to the bid amount.

In the case the exposure index computation unit 702 computes an exposure index, the database management unit 703 records the exposure index in association with the search listing in the search listing database 701 in real time or periodically, thereby updating the search listing database 701.

The user input unit 704 receives a search request including a predetermined keyword from a user. The user may access the search system 700 by using a communication terminal such as PC and may input the search request.

The search listing selection unit 705 selects a predetermined number of search listings whose exposure index ranks high from search listings associated with the keyword by referring to the search listing database 701. On the other hand, the search listing selection unit 705 may previously select a predetermined number of search listings based on the exposure index for each keyword, regardless of an input period of the search request.

The search result list providing unit 706 generates and provides a search result list including the predetermined number of the selected search listings to the user.

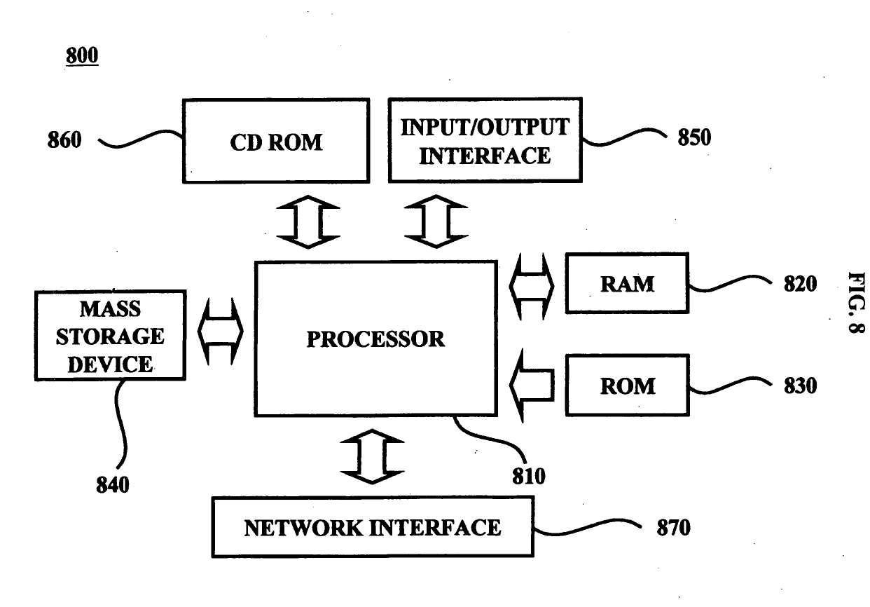

FIG. 8 is an internal block diagram of a general use computer apparatus capable of being employed in performing the search service providing method according to the present invention.

A computer apparatus 800 includes at least one processor 810 connected to a main memory device including a RAM (Random Access Memory) 820 and a ROM (Read Only Memory) 830. The processor 810 is also called as a central processing unit CPU. As well-known to the field of the art, the ROM 830 unidirectionally transmits data and instructions to the CPU, and the RAM 820 is generally used for bidirectionally transmitting data and instructions. The RAM 820 and the ROM 830 may include a certain proper form of a computer readable recording medium. A mass storage device 840 is bidirectionally connected to the processor 810 to provide additional data storage capacity and may be one of the computer readable recording medium. The mass storage device 840 is used for storing programs and data and is an auxiliary memory. A particular mass storage device such as a CD ROM 860 may be used. The processor 810 is connected to at least one input/output interface 850 such as a video monitor, a track ball, a mouse, a keyboard, a microphone, a touch-screen type display, a card reader, a magnetic or paper tape reader, a voice or hand-writing recognizer, a joy stick, and other known computer input/output unit. The processor 810 may be connected to a wired or wireless communication network via a network interface 870. The procedure of the described method can be performed via the network connection. The described devices and tools are well-known to those skilled in the art of computer hardware and software.

The described hardware devices may be formed to be operated by at least one software module in order to perform the operations of the present invention.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching.

Therefore, it is intended that the scope of the invention be defined by the claims appended thereto and their equivalents.

While the present invention has been particularly shown and described with reference to exemplary embodiments thereof, it will be understood by those of ordinary skill in the art that various changes in form and details may be made therein without departing from the spirit and scope of the present invention as defined by the following claims.

### INDUSTRIAL APPLICABILITY

According to the present invention, a search service providing method and search system which select a search listing by considering a bid amount associated with a search listing and an average click rate computed with respect to the search listing are provided.

Also, according to the present invention, a search service providing method and search system which select a search listing based on a bid amount and an average click rate, thereby guaranteeing quality of a search listing provided according to a keyword advertisement service are provided.

Also, according to the present invention, a search service providing method and search system which select a search listing by using an average click rate whose variance is smaller than a click rate such that an advertiser may estimate what search listing is selected are provided.

Also, according to the present invention, a search service providing method and search system which determine a value of M according to a number of times of inputting a keyword to compute an average click rate and compute an average click rate by reflecting click rate of unit period whose number of exposures, for example, a number of times of providing a search listing, is more than the value of M, thereby more guaranteeing a smaller width of a change are provided.

1. A method of providing search service in a search system, comprising:
maintaining a database, the database storing a plurality of search listings, wherein each stored search listing is associated with at least one keyword, an advertiser, a bid amount, and an exposure index;
computing an average click rate for each of the search listing, the average click rate being an average value of a plurality of unit period click rates for the search listings, wherein each of the unit period click rates is obtained by dividing the number of clicks on the search listing by the number of impressions of the search listing for a specified unit time period;
computing the exposure index based, at least in part, upon the average click rate and the bid amount for each search listing;
updating the exposure index stored in the database;
searching the database for search listings corresponding to a keyword in response to a search request received from a searcher;
identifying a predetermined number of search listings having keywords generating a match with the search request, the predetermined number of the search listings being selected based, at least in part, upon the exposure index;
generating a search result list by arranging the identified search listings; and
displaying the generated search result list in response to the search request.

2. The method of claim 1, wherein the exposure index is a multiplication value of the average click rate and the bid amount for each search listing.

3. The method of claim 1, wherein the step of computing the exposure index comprises:
computing a weighted average click rate by adding a first weight value to the average click rate;
computing a weighted bid amount by adding a second weight value to the bid amount;
computing a multiplication value of the weighted average click rate and the weighted bid; and
determining the computed multiplication value to be the exposure index.

4. The method of claim 1, wherein:
the plurality of unit period click rates for the average click rate include unit period click rates whose number of exposure exceeds a predetermined value during each specified unit time period.

5. The method of claim 4, further comprising:
computing an average value of input numbers, the input number being the number of times of inputting the keyword associated with the search listing by searchers; and
determining the predetermined value based upon the computed average value of the input numbers.

6. (canceled)

7. A computer readable recording medium recording a program for implementing the method recited in claim 1.

8. A search system providing search service, comprising:
a database, the database storing a plurality of search listings, wherein each stored search listing is associated with at least one keyword, an advertiser, a bid amount, and an exposure index;
an exposure index computation unit configured for computing an average click rate for each of the search listings, the average click rate being an average value of a plurality of unit period click rates for the search listings, wherein each of the unit period click rates is obtained by dividing the number of clicks on the search listing by the number of impression of the search listing for a specified unit time period and for computing the exposure index based, at least in part, upon the average click rate and the bid amount for each search listing;
a database management unit configured for updating the exposure index stored in the database;
a search result selection unit configured for identifying a predetermined number of search listings having keywords generating a match with the search request, the predetermined number of the search listings being selected based, at least in part, upon the exposure index; and
a search result list providing unit configured for generating a search result list by arranging the identified search listings.

9. The system of claim 8, wherein:
the plurality of unit period click rates for the average click rate include unit period click rates whose number of exposure exceeds a predetermined value during each specified unit time period.

10. The system of claim 9, wherein the exposure index computation unit:
computes an average value of input numbers, the input number being the number of times of inputting the keyword associated with the search listing by searchers; and
determines the predetermined value based upon the computed average value of the input numbers.

11. The system of claim 8, wherein the exposure index computation unit:
computes a weighted average click rate by adding a first weight value to the average click rate;
computes a weighted bid amount by adding a second weight value to the bid amount;
computes a multiplication value of the weighted average click rate and the weighted bid; and
determines the computed multiplication value to be the exposure index.

12. The method of claim 4, wherein the step of computing the average click rate comprises:
identifying a predetermined number of recent unit click rates whose number of exposures exceeds a predetermined value during each specified unit time period; and
computing the average click rate, wherein the average click rate is an average value of the identified unit click rates.
